(19) United States
(12) Patent Application Publication
(10) Pub. No.: US 2025/0064128 A1
(43) Pub. Date: Feb. 27, 2025

(54) RESISTIVE HEATER FOR USE IN AEROSOL GENERATION APPARATUS, AND AEROSOL GENERATION APPARATUS

(71) Applicant: CHONGQING JIANG TAO TECHNOLOGY CO., LTD., Chongqing (CN)

(72) Inventors: Chen Wang, Chongqing (CN); Zhongli Xu, Chongqing (CN); Yonghai Li, Chongqing (CN)

(21) Appl. No.: 18/722,655

(22) PCT Filed: Dec. 23, 2022
(86) PCT No.: PCT/CN2022/141652

§ 371 Date: Jun. 21, 2024

(30) Foreign Application Priority Data
Dec. 24, 2021 (CN) 202111609809.0
Dec. 24, 2021 (CN) 202111609823.0

(51) Int. Cl. A24F 40/465; H05B 3/14

(52) U.S. Cl. CPC A24F 40/465; H05B 3/141

(57) ABSTRACT

A resistive heater (30a) for use in an aerosol generation apparatus, and an aerosol generation apparatus are provided. The resistive heater (30a) for use in the aerosol generation apparatus includes conductive ceramic; and the resistivity of the conductive ceramic is between 1×10⁻⁴ Ω·cm and 1.3×10⁻¹ Ω·cm.

### CROSS-REFERENCE TO RELATED APPLICATIONS

This application is a National Phase entry under 35 U.S.C § 371 of International Application No. PCT/CN2022/141652, with an international filing date of Dec. 23, 2022, which is based upon and claims priority to Chinese Patent Application No. 2021116098090 filed on Dec. 24, 2021 and Chinese Patent Application No. 2021116098230 filed on Dec. 24, 2021, which are incorporated herein by reference in their entirety.

### TECHNICAL FIELD

This application relates to the field of atomization technologies, and in particular, to a resistive heater for use in an aerosol generation apparatus, and an aerosol generation apparatus.

### BACKGROUND

Currently, a resistive heater is roughly divided into two types: One is a zirconia ceramic sheet, where a thick film circuit is printed on a surface of the zirconia ceramic sheet to form a ceramic heating sheet; and the other is an aluminum oxide rod core, where an aluminum oxide cast sheet printed with a circuit is wrapped on a surface of the aluminum oxide rod core to form a ceramic heating needle. In other words, the existing two ceramic heating bodies both use ceramic as carriers, and conductive paste is printed on the carriers, to form the heating bodies. The ceramic is insulating, and a resistor is energized and generates heat after a resistive circuit is printed, so that the heat is conducted to the ceramic, to bake a cigarette to complete a heating and atomization process.

### SUMMARY

A resistive heater for use in an aerosol generation apparatus is provided in some embodiments, including conductive ceramic, where resistivity of the conductive ceramic ranges from 1×10⁻⁴ Ω·cm to 1.3×10⁻¹ Ω·cm.

A resistive heater for use in an aerosol generation apparatus is provided in some embodiments, including conductive ceramic, wherein a material of the conductive ceramic includes a main component and a doping component; a mass percentage of the main component in the conductive ceramic is greater than 80% and less than or equal to 98%;
the main component includes a first metal oxide, and the doping component includes a second metal oxide; and a valence of metal in the first metal oxide is different from a valence of metal in the second metal oxide.

An aerosol generation apparatus is provided in some embodiments, configured to heat an aerosol generation product to generate an aerosol for inhalation, and including: a chamber and a resistive heater, wherein the chamber is for receiving the aerosol generation product; and the resistive heater is configured to heat the aerosol generation product received in the chamber, wherein the resistive heater is the resistive heater for use in an aerosol generation apparatus according to any one of the foregoing technical solutions.

### BRIEF DESCRIPTION OF THE DRAWINGS

To describe the technical solutions of embodiments of this application more clearly, the following briefly introduces the accompanying drawings required for describing the embodiments. Apparently, the accompanying drawings in the following descriptions merely show some embodiments of this application, and a person of ordinary skill in the art may still obtain other drawings from the accompanying drawings without creative efforts.

FIG. 1 is a schematic structural diagram of an aerosol generation apparatus according to an embodiment of this application;

FIG. 2 is a schematic structural diagram of a resistive heater for use in an aerosol generation apparatus according to an embodiment of this application;

FIG. 3 is a schematic exploded view of a specific structure of the resistive heater shown in FIG. 2;

FIG. 4A is a longitudinal sectional view of a resistive heater according to an embodiment of this application;

FIG. 4B is a longitudinal sectional view of a resistive heater according to another embodiment of this application;

FIG. 5 is a schematic structural diagram of a position A of the resistive heater for use in an aerosol generation apparatus shown in FIG. 2;

FIG. 6 is a schematic diagram of measuring resistance of a resistive heater according to this application;

FIG. 7 is a schematic structural diagram of an aerosol generation apparatus according to another embodiment of this application;

FIG. 8 is a schematic structural diagram of an embodiment of a resistive heater for use in the aerosol generation apparatus provided in FIG. 7;

FIG. 9 is a schematic structural diagram of an aerosol generation apparatus according to still another embodiment of this application;

FIG. 10 is a schematic structural diagram of an atomizer of the aerosol generation apparatus provided in FIG. 9; and

FIG. 11 is a schematic structural diagram of a heating assembly of the atomizer provided in FIG. 10.

### DETAILED DESCRIPTION

The following clearly and completely describes the technical solutions in embodiments of this application with reference to the accompanying drawings in the embodiments of this application. Apparently, the described embodiments are merely some embodiments of this application rather than all embodiments. Based on the embodiments of this application, all other embodiments obtained by a person of ordinary skill in the art without creative efforts shall fall within the protection scope of this application.

In the following descriptions, for the purpose of explanation rather than limitation, specific details such as a specific system structure, interface, and technology are provided, to facilitate a thorough understanding of this application.

Terms “first”, “second”, and “third” in this application are merely used for the purpose of description, and shall not be construed as indicating or implying relative importance or implying a quantity of indicated technical features. Therefore, features limited by “first”, “second”, and “third” may explicitly indicate or implicitly include at least one of the features. In descriptions of this application, unless otherwise stated, “plurality of” means two or more, such as two or three. All directional indications (such as up, down, left, right, front, and back) in the embodiments of this application are merely used for explaining a relative positional relationship, a motion situation, and the like between various components in a specific posture (as shown in the figure). If the specific posture changes, the directional indication also correspondingly changes. Terms “include”, “comprise”, “contain”, and any other variants in the embodiments of this application mean to cover the non-exclusive inclusion. For example, a process, method, system, product, or device that includes a list of steps or units is not limited to the listed steps or units, but optionally also includes a step or a unit that is not listed, and optionally also includes another step or assembly inherent to such a process, method, system, product, or device.

“Embodiment” mentioned in the specification means that specific features, structures, or characteristics described with reference to the embodiments may be included in at least one embodiment of this application. That a recited phrase appears in various places in the specification does not necessarily all refer to a same embodiment, nor is an independent embodiment exclusive with other embodiments or an alternative embodiment to other embodiments. A person skilled in the art explicitly or implicitly understands that, the embodiments described in the specification may be combined with other embodiments.

Because the conductive paste is printed on a surface of the ceramic for the resistive heaters known to the inventors, and the printed paste further needs to be processed and sintered again after the ceramic is sintered, costs are increased. In addition, a thermal expansion coefficient of resistive paste is different from that of the ceramic, and friction due to frequent use easily causes circuit falling, affecting product experience and service life. In view of this, the present application discloses a resistive heater for use in an aerosol generation apparatus and an aerosol generation apparatus. This application is described in detail below with reference to the accompanying drawings and the embodiments.

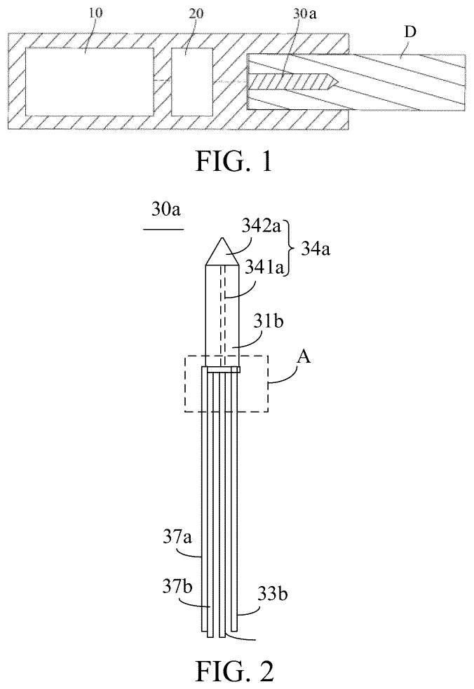

FIG. 1 is a schematic structural diagram of an aerosol generation apparatus according to an embodiment of this application. In this embodiment, an aerosol generation apparatus is provided, where a construction of the aerosol generation apparatus includes: a chamber, a power supply assembly 10, a circuit 20, and a resistive heater 30a.

An aerosol generation product D is removably received in the chamber. In one or more embodiments, the aerosol generation product D is made of a tobacco-containing material that releases a volatile compound from a substrate when being heated; or a non-tobacco material that can be heated and suitable for electric heating to produce smoke. In one or more embodiments, the aerosol generation product D is made of a solid substrate, which may include one or more of powders, granules, fragments, strips, or flakes of one or more of vanilla leaves, tobacco leaves, homogeneous tobacco, and expanded tobacco. Alternatively, the solid substrate may include an additional tobacco or non-tobacco volatile aroma compound, so that the compound is released when the substrate is heated.

At least a part of the resistive heater 30a extends in the chamber, and the resistive heater 30a is inserted into the aerosol generation product D for heating when the aerosol generation product D is received in the chamber, so that the aerosol generation product D releases a plurality of volatile compounds, and the volatile compounds are formed through heating treatment. In a specific embodiment, the resistive heater 30a has a free front end and a rear end opposite to each other in a length direction of the resistive heater 30a. The following defines an end inserted into the aerosol generation product D as the free front end, and an end for fixing or assembling with another assembly as the rear end. The power supply assembly 10 is configured to supply power; and the circuit 20 is configured to guide a current between the power supply assembly 10 and the resistive heater 30a.

The resistive heater 30a is prepared by using a conductive ceramic material. Compared with the resistive heaters known to the inventors, conductive ceramic itself has a conductive capability, so that a circuit is prevented from being printed on a surface of the ceramic, and a problem of circuit falling caused by friction due to frequent use is also avoid, which is beneficial to improving use experience of a user and prolonging service life of the aerosol generation apparatus. The resistive heater 30a may be entirely prepared by using the conductive ceramic material; or may be partially prepared by using the conductive ceramic material. Specifically, the resistive heater 30a is designed as needed.

In an implementation, the resistive heater 30a is constructed in an elongated pin, needle, stick, rod, or sheet shape, and can be inserted into the aerosol generation product D during use to heat the aerosol generation product D. In another implementation, the resistive heater 30a is constructed in a tube shape, and the aerosol generation product D is received in the tube shape, so that the aerosol generation product D is heated. A shape and a size of the resistive heater 30a are designed as needed, as long as the aerosol generation product D can be better atomized.

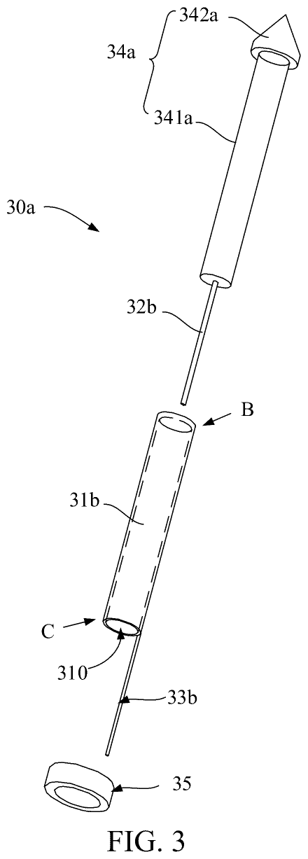

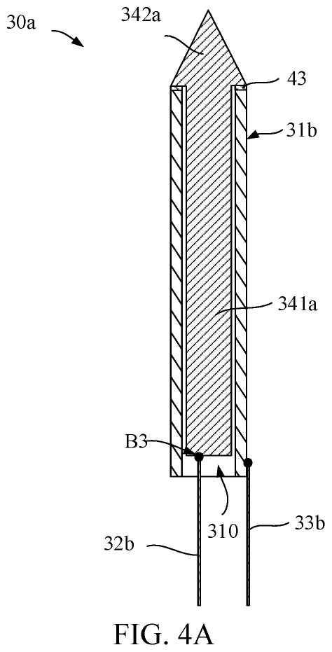

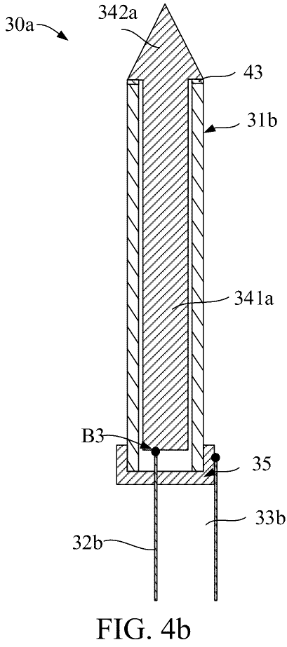

This application provides a resistive heater 30a. Specifically, refer to FIG. 2 to FIG. 4B. FIG. 2 is a schematic structural diagram of a resistive heater according to an embodiment of this application; FIG. 3 is a schematic exploded view of a specific structure of the resistive heater shown in FIG. 2; FIG. 4A is a longitudinal sectional view of a resistive heater according to an embodiment of this application; and FIG. 4B is a longitudinal sectional view of a resistive heater according to another embodiment of this application. In an embodiment, a resistive heater 30a is provided. The resistive heater 30a includes a conductive ceramic body 31b, a first lead 32b, a second lead 33b, and a base body 34a.

The conductive ceramic body 31b is configured to be inserted into and heat an aerosol generation product D when energized. In addition, refer to FIG. 3. The conductive ceramic body 31b is constructed to extend in a length direction of the resistive heater 30a, and has a first end B and a second end C opposite to each other in the length direction of the resistive heater 30a; and during being inserted into the aerosol generation product D, the first end B of the conductive ceramic body 31b is first inserted into the aerosol generation product D. Specifically, a material of the conductive ceramic body 31b may be conductive ceramic, and the conductive ceramic is ceramic that may generate a high temperature through current heating or may be conductive in a high-temperature state without melting or oxidizing, for example, tin oxide, zinc oxide, barium titanate, zirconium oxide, or β-aluminum oxide. In a specific embodiment, a material formula may be adjusted and a proper forming process is selected based on a requirement such as a design specification, a shape, or heating performance of the conductive ceramic body 31b, to obtain a conductive ceramic material with a required resistance value.

Specifically, in this embodiment, as shown in FIG. 3, the conductive ceramic body 31b is in a tube shape. A through hole 310 is formed in the conductive ceramic body 31b, where an aperture of the through hole 310 is smaller than 0.5 mm. Compared with a conductive ceramic body 31b with a U-shaped structure, strength of the conductive ceramic body 31b is greatly improved, which facilitates insertion of the conductive ceramic body 31b into the aerosol generation product D, and also prolongs service life of the conductive ceramic body 31b. In addition, given that the aperture of the conductive ceramic body 31b is small, the through hole 310 does not need to be filled, thereby effectively reducing process complexity. Specifically, the radial sizes of the conductive ceramic body 31b along its length direction are all the same.

A tube structure of the conductive ceramic body 31b may be prepared by mold forming and sintering, or may be prepared by machining, thin hole discharging, or the like after the ceramic is sintered. FIG. 3 shows the tube structure prepared by thin hole discharging.

As shown in FIG. 4A and FIG. 4B, the base body 34a extends in the length direction of the resistive heater 30a; and specifically, the conductive ceramic body 31b surrounds at least a part of the base body 34a, and at least a part of the conductive ceramic body 31b is supported by the base body 34a. In a specific embodiment, as shown in FIG. 4A and FIG. 4B, the base body 34a is a conductor, and the first lead 32b is connected to the base body 34a, to form conduction with the first end B of the conductive ceramic body 31b. Refer to FIG. 4A or FIG. 4B, B3 is a connection point between the first lead 32b and the base body 34a, or a connection point between the second lead 33b and the conductive ceramic body 31b.

Specifically, as shown in FIG. 3, the base body 34a is a self-supporting columnar body and is in a pin or needle shape. Specifically, the base body 34a includes an extension portion 341a and a tapered portion 342a connected in an axial direction. As shown in FIG. 4A, the extension portion 341a passes through the through hole 310 of the conductive ceramic body 31b and is sleeved in the conductive ceramic body 31b. The conductive ceramic body 31b is arranged around the extension portion 342a and is insulated from the extension portion 341a. Certainly, the extension portion 341a and the conductive ceramic body 31b may also be integrally formed by using an isostatic pressing method, a die-casting forming method, or the like. In a specific embodiment, a proper insulation solution may be selected based on technical requirements such as temperature resistance, voltage resistance, and insulation time, and a material of the extension portion 341a. In an implementation, a first insulation medium layer is formed on an outer side wall of the extension portion 341a, so that the extension portion 341a is insulated from the conductive ceramic body 31b. In another implementation, a second insulation medium layer is arranged on an inner surface of a hollow structure of the conductive ceramic body 31b, so that the extension portion 341a is insulated from the conductive ceramic body 31b. Certainly, the extension portion 341a and the inner surface of the hollow structure of the conductive ceramic body 31b may also be spaced apart, so that the extension portion 341a is insulated from the conductive ceramic body 31b. The insulation medium layer and/or the second insulation medium layer may be a coating/film of glass glaze, inorganic glue insulation, chromium-including tungsten carbide, aluminum oxide, magnesium silicate, magnesium oxide, or the like. A length of the extension portion 341a may be the same as a length of the conductive ceramic body 31b, or may be shorter than the length of the conductive ceramic body 31b. Specifically, the length of the extension portion 341a may be adjusted based on matching of an energy requirement of the aerosol generation product D.

A radial size of the tapered portion 342a toward an end of the extension portion 341a is larger than a radial size of the extension portion 341a and larger than the inner diameter of the conductive ceramic body 31b. Specifically, the tapered portion 342a is exposed outside the conductive ceramic body 31b, a free front end of the resistive heater 30a is defined by the tapered portion 342a, and the tapered portion 342a abuts against an end portion of the conductive ceramic body 31b close to the free front end. In a specific embodiment, as shown in FIG. 4A or FIG. 4B, a first conductive medium 43 is further arranged between the tapered portion 342a and an end surface of the first end B of the conductive ceramic body 31b. Specifically, the tapered portion 342a is electrically connected to the first end B of the conductive ceramic body 31b through the first conductive medium 43. In this way, effective contact between the tapered portion 342a and the conductive ceramic body 31b can be ensured, and the tapered portion 342a and the conductive ceramic body 31b can also be tightly fixed. The first conductive medium 43 may be conductive adhesive, conductive silver paste, soldering tin, solder, or the like. Specifically, the first conductive medium 43 may be coated on a side surface of the tapered portion 342a toward the conductive ceramic body 31b, or may be coated on an end surface of an end of the conductive ceramic body 31b toward the tapered portion 342a.

Certainly, the tapered portion 342a may also be arranged outside the conductive ceramic body 31b and electrically connected to a side wall surface of the first end B of the conductive ceramic body 31b. In a specific embodiment, to facilitate insertion of the resistive heater 30a into the aerosol generation product D, ensure that insertion is smooth and safe, and avoid sticky product residue, the radial size of the tapered portion 342a may be gradually reduced in a direction away from the extension portion 341a. Specifically, the tapered portion 342a may be in a conical shape or a smooth transition shape.

Specifically, a material of the extension portion 341a and/or the tapered portion 342a may be a metal material such as stainless steel, iron-aluminum alloy, iron-nickel alloy, copper, or aluminum. The extension portion 341a and the tapered portion 342a may be integrally formed.

Refer to FIG. 3. The first lead 32b is electrically connected to an end of the extension portion 341a of the base body 34a away from the tapered portion 342a, to connect to the first end B of the conductive ceramic body 31b through the base body 34a. Specifically, the first lead 32b may be connected to a central position or an edge position of the extension portion 341a, as long as the first lead 32b is not in contact with the conductive ceramic body 31b to avoid interference.

The second lead 33b is electrically connected to the second end C of the conductive ceramic body 31b. In a specific embodiment, a second conductive medium is formed on a surface of the second end C of the conductive ceramic body 31b. Specifically, the second lead 33b is electrically connected to the second conductive medium, to implement electrical connection with the second end C of the conductive ceramic body 31b through the second conductive medium. In this way, a problem of falling of the second lead 33b can be effectively reduced, and contact resistance between the second lead 33b and the conductive ceramic body 31b is much less than resistance of the conductive ceramic body 31b, to prevent the conductive ceramic body 31b from being unable to entirely generate heat because heating points of the conductive ceramic body 31b gather at a connection position of the second lead 33b and the conductive ceramic body 31b. The first conductive medium 43 and/or the second conductive medium may be conductive adhesive or paste with high conductivity; and the first conductive medium 43 and the second conductive medium may be electrode coatings formed by burning and infiltrating silver.

The first lead 32b is a negative lead, and the second lead 33b is a positive lead, respectively in communication with a positive electrode and a negative electrode of a power supply assembly 10, so that a current is introduced, to perform a heating operation. Certainly, the first lead 32b may alternatively be a positive lead, and the second lead 33b is a negative lead. A material of the first lead 32b and/or the second lead 33b is generally selected as a material with high conductivity, such as nickel or silver. Alternatively, another material may be selected or surface treatment may be performed based on an actual design solution. Specifically, the first lead 32b and/or the second lead 33b may be connected to a corresponding component by welding.

The first lead 32b is electrically connected to the first end B of the conductive ceramic body 31b, and the second lead 33b is electrically connected to the second end C of the conductive ceramic body 31b, so that a current can flow from an end portion of the conductive ceramic body 31b to the other end portion, for example, flow from the first end B to the second end C. A person skilled in the art may be understood that, the U-shaped conductive ceramic body has a problem that a groove position opened in the middle of the conductive ceramic body is not suitable, causing width sizes of the conductive ceramic body on both left and right sides to be different. This seriously affects distribution of the current on the conductive ceramic body, and causes uneven current distribution on the conductive ceramic body, causing poor consistency of an aerosol released by an aerosol generation apparatus and affecting a taste. In this application, the width size or the radial size of the conductive ceramic body 31b remains unchanged in the length direction of the conductive ceramic body 31b. In other words, the width size or the radial size of the conductive ceramic body 31b remains unchanged in a current direction, to effectively ensure heating uniformity of the conductive ceramic body 31b, thereby effectively improving an inhaling taste of an aerosol formed by atomization.

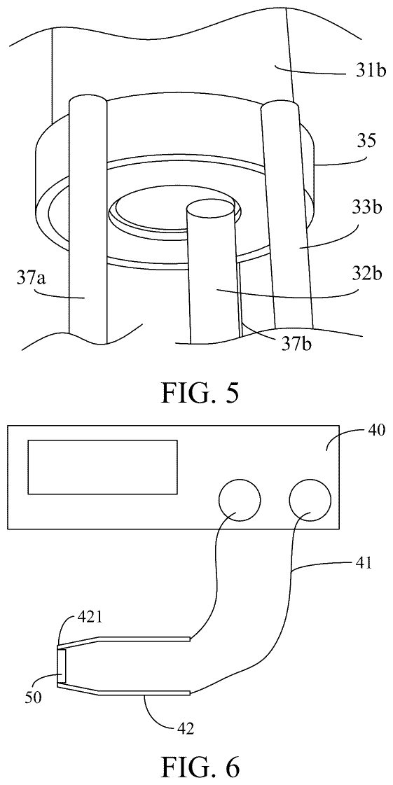

Further, as shown in FIG. 2, FIG. 3, and FIG. 4B, the resistive heater 30a further includes an electrode cap 35. The electrode cap 35 is in a groove structure, and a hole is provided on a bottom wall of the electrode cap 35, and the first lead 32b connected to the base body 34a extends outside the conductive ceramic body 31b through the hole of the electrode cap 35. As shown in FIG. 5, the electrode cap 35 covers the second end C of the conductive ceramic body 31b; and the electrode cap 35 is separately in contact with an end surface of the second end C of the conductive ceramic body 31b and a side wall surface of the second end C, to be electrically connected to the second end C. In this embodiment, specifically, the second lead 33b is electrically connected to the electrode cap 35, to improve connection stability between the second lead 33b and the electrode cap 35 when the contact resistance is further reduced. Further, to reduce the contact resistance, silver paste or silver paint with high conductivity may be coated on an inner surface of the electrode cap 35. A material of the electrode cap 35 is metal or alloy, such as copper or silver.

Further, in an embodiment, the resistive heater 30a further includes a temperature sensor, where the temperature sensor is fixed on the conductive ceramic body 31b, to detect a temperature of the conductive ceramic body 31b.

In another embodiment, refer to FIG. 2 and FIG. 5. FIG. 5 is a schematic structural diagram of a position A of the resistive heater 30a of an aerosol generation apparatus shown in FIG. 2. The first lead 32b includes a first couple wire 37a and a second couple wire 37b, and the first couple wire 37a and the second couple wire 37b are made of different materials, for example, the first couple wire 37a and the second couple wire 37b are respectively made of nickel chromium and nickel silicon, to form a thermocouple for sensing a temperature between the first couple wire 37a and the second couple wire 37b. Specifically, the first couple wire 37a and the second couple wire 37b are both electrically connected to the electrode cap 35, to measure the temperature of the conductive ceramic body 31b through a thermoelectric effect, thereby facilitating control of the temperature of the conductive ceramic body 31b. Certainly, because there is heat conduction between the base body 34a and the conductive ceramic body 31b, the first couple wire 37a and the second couple wire 37b may also be electrically connected to the base body 34a. This is not limited in this application.

In a resistive heater 30a provided in this embodiment, an axial through hole 310 not penetrating through a side wall of a conductive ceramic body 31b is provided on the conductive ceramic body 31b, and an aperture of the through hole 310 is smaller than 0.5 mm. Compared with the existing U-shaped conductive ceramic body 31b, the aperture of the through hole 310 is much smaller than a groove width of the U-shaped conductive ceramic body 31b, thereby greatly improving strength of the conductive ceramic body 31b, enhancing reliability and resistance, and reducing the process difficulty. In addition, an end of a base body 34a is connected to a first end B of the conductive ceramic body 31b, and the base body 34a extends to a second end C of the conductive ceramic body 31b in a length direction of the conductive ceramic body 31b; and a first lead 32b is electrically connected to a second end C of the conductive ceramic body 31b, and a second lead 33b is electrically connected to the second end C of the conductive ceramic body 31b, so that a current loop is formed in the conductive ceramic body 31b in the length direction of the conductive ceramic body 31b. Compared with the conductive ceramic body 31b with a U-shaped structure, heating uniformity of the conductive ceramic body 31b is effectively improved. In addition, the second lead 33b is electrically connected to the conductive ceramic body 31b through a second conductive medium layer, so that a problem of falling of the second lead 33b can be effectively reduced, and contact resistance between the second lead 33b and the conductive ceramic body 31b is much less than resistance of the conductive ceramic body 31b, to prevent the conductive ceramic body 31b from being unable to entirely generate heat because heating points of the conductive ceramic body 31b gather at a connection position of the second lead 33b and the conductive ceramic body 31b; and avoid causing poor consistency of an aerosol released by an aerosol generation apparatus and affecting a taste due to uneven current distribution of the conductive ceramic body 31b. In addition, assembly of the resistive heater 30a provided in this embodiment is simple, which is beneficial to achieving stable mass production of products, and ensuring performance consistency of the products.

A material of conductive ceramic is described in detail below.

Resistivity of the conductive ceramic provided in this application ranges from 1×10⁻⁴ Ω·cm and less than or equal to 1.3×10⁻¹ Ω·cm, which meets a requirement that an aerosol generation product D releases a plurality of volatile compounds, and the conductive ceramic itself has a heating function, so that a circuit is prevented from being printed on a surface of the ceramic, and a problem of circuit falling caused by friction due to frequent use is also avoid, which is beneficial to improving use experience of a user and prolonging service life of an aerosol generation apparatus.

Optionally, resistance of the resistive heater 30a prepared by using the conductive ceramic provided in this application is greater than or equal to 0.036Ω and less than or equal to 1.5Ω.

Optionally, porosity of the conductive ceramic provided in this application ranges from 0.01% to 10%. It may be understood that, the porosity of the conductive ceramic may be designed as needed, that is, required porosity can be obtained by properly adjusting a material proportion.

In an implementation, the resistive heater 30a prepared by using the conductive ceramic is in a needle shape, with a diameter of 1.95 mm, a length of 16.31 mm, and a tip height of 0.5 mm; and the resistance of the resistive heater 30a is 0.75Ω, and resistivity of the resistive heater 30a is calculated to be 2.27×10⁻³ Ω·cm.

Specifically, for a method for measuring the resistance of the resistive heater 30a, refer to FIG. 6. FIG. 6 is a schematic diagram of measuring resistance of a resistive heater according to this application. In this application, resistance of the conductive ceramic is measured according to GB/T 5594.5-1985 Test Method for Properties of Structure Ceramic Used in Electronic Components—Test Method for Volume Resistivity. Refer to FIG. 6. An LCR tester 40 is connected to two leads 41, and end portions of the two leads 41 are respectively connected to a measuring clamp 42. The measuring clamp 42 includes a clamping portion 421, where the clamping portion 421 is configured to clamp conductive ceramic 50. It may be understood that, the clamping portion 421 clamps two ends of the conductive ceramic 50. Resistivity of the conductive ceramic is measured by using the LCR tester 40. The LCR tester 40 can accurately and stably measure various component parameters, and is mainly for testing inductance, capacitance, and resistance, where “L” indicates the inductance, “C” indicates the capacitance, and “R” indicates the resistance.

In an implementation, the resistive heater 30a prepared by using the conductive ceramic is in a needle shape, with a diameter of 1.95 mm, a length of 18 mm, and a tip height of 0.5 mm; and resistance of the resistive heater 30a measured by using the LCR tester 40 is 0.75Ω, and resistivity of the resistive heater 30a is calculated to be 2.27×10⁻³ Ω·cm.

In an implementation, the resistive heater 30a prepared by using the conductive ceramic is in a sheet shape, with a length of 16 mm, a width of 4.5 mm, and a thickness of 0.45 mm; and resistance of the resistive heater 30a measured by using the LCR tester 40 is 0.7Ω, and resistivity of the resistive heater 30a is calculated to be 3.9×10⁻³ Ω·cm.

In an implementation, the resistive heater 30a prepared by using the conductive ceramic is in a tube shape, with a length of 29 mm, an inner diameter of 7.2 mm, and an outer diameter of 8.5 mm; and resistance of the resistive heater 30a measured by using the LCR tester 40 is 1.5Ω, and resistivity of the resistive heater 30a is calculated to be 8.98×10⁻² Ω·cm.

In an implementation, the resistive heater 30a prepared by using the conductive ceramic is in a tube shape, with a length of 29 mm, an inner diameter of 7.2 mm, and an outer diameter of 9.2 mm; and resistance of the resistive heater 30a measured by using the LCR tester 40 is 1.5Ω, and resistivity of the resistive heater 30a is calculated to be 13×10⁻² Ω·cm.

In an implementation, the resistive heater 30a prepared by using the conductive ceramic is in a tube shape, with a length of 49 mm, an inner diameter of 5.5 mm, and an outer diameter of 6.7 mm; and resistance of the resistive heater 30a measured by using the LCR tester 40 is 1.5Ω, and resistivity of the resistive heater 30a is calculated to be 3.52×10⁻² Ω·cm.

A material of the conductive ceramic provided in this application includes a main component and a doping component, where the main component includes a first metal oxide, and the doping component includes a second metal oxide; and a valence of metal in the first metal oxide is different from a valence of metal in the second metal oxide. A mass percentage of the main component in the conductive ceramic is greater than 80% and less than or equal to 98%. Further, a mass percentage of the doping component in the conductive ceramic is greater than 0.5% and less than or equal to 19%. In this implementation, the metal in the second metal oxide obtained enough energy into a lattice of the first metal oxide, to play a role of donor doping, that is, through ion replacement at a high temperature, carrier concentration increases, to implement conductivity of the ceramic.

In an implementation, the valence of the metal in the first metal oxide is less than the valence of the metal in the second metal oxide. Optionally, the valence of the metal in the second metal oxide is not less than 3.

When the main component includes zinc oxide, and the doping component includes at least one of aluminum oxide, zirconium dioxide, titanium dioxide, or niobium pentoxide, the resistivity of the conductive ceramic obtained based on the main component and the doping component ranges from 1×10⁻³ Ω·cm to 6×10⁻² Ω·cm. A mass percentage of zinc oxide in the conductive ceramic ranges from 94% to 98%; and the doping component includes aluminum oxide, and a mass percentage of aluminum oxide in the conductive ceramic ranges from 0.5% to 5%.

Optionally, the material of the conductive ceramic includes zinc oxide with the mass percentage of 94% to 98%, aluminum oxide with a mass percentage of 0.8% to 5%, titanium dioxide with a mass percentage of 0% to 1%, and zirconium dioxide with a mass percentage of 0% to 0.5%. Specific embodiments are as follows:

Embodiment 1: Zinc oxide (ZnO) powder, aluminum oxide (Al₂O₃) powder, and titanium dioxide (TiO₂) powder were weighed at a mass ratio of 97:2:1, added to aqueous solution, wetly ground for 24 h to 48 h and evenly mixed, then dried, and sifted through a sieve with a mesh of 5000 to 8000, to obtain mixed powder; and a polyvinyl alcohol (PVA) forming agent or a polyethylene glycol (PEG) forming agent was added to the mixed powder, wet grinding and mixing, drying, and sifting were performed, then mold pressing was performed under a pressure of 20 MPa to 40 MPa to form a designed shape, isostatic pressing was performed under a pressure of 100 MPa to 300 MPa to obtain a green body, and after the forming agent was removed, pressureless sintering was performed at 1100° C. to 1700° C. for 5 h to 12 h, to obtain conductive ceramic. Resistivity of the conductive ceramic was 2.26×10⁻³ Ω·cm, and porosity of the conductive ceramic was 5%. At the high temperature, Al³⁺ and Ti⁴⁺ obtained enough energy to enter a lattice of ZnO and replaced Zn²⁺, to provide an excess of free electrons, thereby playing the role of donor doping and improving conductivity of the ceramic, so that the ceramic can spontaneously generate heat.

In Embodiment 1, the conductive ceramic was approximately in a sheet shape, with a length of 19.9 mm, a width of 5 mm, and a thickness of 2.5 mm. Resistance of the conductive ceramic measured by using the LCR tester 40 was 36 mΩ.

Embodiment 2: Zinc oxide (ZnO) powder, aluminum oxide (Al₂O₃) powder, and titanium dioxide (TiO₂) powder were weighed at a mass ratio of 94.5:3:0.5, added to aqueous solution, wetly ground for 24 h to 48 h and evenly mixed, then dried, and sifted through a sieve with a mesh of 5000 to 8000, to obtain mixed powder; and a polyvinyl alcohol (PVA) forming agent or a polyethylene glycol (PEG) forming agent was added to the mixed powder, wet grinding and mixing, drying, and sifting were performed, then mold pressing was performed under a pressure of 20 MPa to 40 MPa to form a designed shape, isostatic pressing was performed under a pressure of 100 MPa to 300 MPa to obtain a green body, and after the forming agent was removed, pressureless sintering was performed at 1100° C. to 1700° C. for 5 h to 12 h, to obtain conductive ceramic. Resistivity of the conductive ceramic was 9.6×10⁻³ Ω·cm, and porosity of the conductive ceramic was 3%. At the high temperature, Al³⁺ and Ti⁴⁺ obtained enough energy to enter a lattice of ZnO and replaced Zn²⁺, to provide an excess of free electrons, thereby playing the role of donor doping and improving conductivity of the ceramic, so that the ceramic can spontaneously generate heat.

In Embodiment 2, the conductive ceramic was approximately in a sheet shape, with a length of 19 mm, a width of 4 mm, and a thickness of 2 mm. Resistance of the conductive ceramic measured by using the LCR tester 40 was 0.23Ω.

Embodiment 3: Zinc oxide (ZnO) powder, aluminum oxide (Al₂O₃) powder, and titanium dioxide (TiO₂) powder were weighed at a mass ratio of 97:2:1, added to aqueous solution, wetly ground for 24 h to 48 h and evenly mixed, then dried, and sifted through a sieve with a mesh of 5000 to 8000, to obtain mixed powder; and a polyvinyl alcohol (PVA) forming agent or a polyethylene glycol (PEG) forming agent was added to the mixed powder, wet grinding and mixing, drying, and sifting were performed, then mold pressing was performed under a pressure of 20 MPa to 40 MPa to form a designed shape, isostatic pressing was performed under a pressure of 100 MPa to 300 MPa to obtain a green body, and after the forming agent was removed, pressureless sintering was performed at 1100° C. to 1700° C. for 5 h to 12 h, to obtain conductive ceramic. Resistivity of the conductive ceramic was 5.4×10⁻² Ω·cm, and porosity of the conductive ceramic was 5%. At the high temperature, Al³⁺ and Ti⁴⁺ obtained enough energy to enter a lattice of ZnO and replaced Zn²⁺, to provide an excess of free electrons, thereby playing the role of donor doping and improving conductivity of the ceramic, so that the ceramic can spontaneously generate heat.

In Embodiment 3, the conductive ceramic was approximately in a sheet shape, with a length of 19 mm, a width of 4 mm, and a thickness of 2 mm. Resistance of the conductive ceramic measured by using the LCR tester 40 was 1.3Ω.

Embodiment 4: Zinc oxide (ZnO) powder, aluminum oxide (Al₂O₃) powder, titanium dioxide (TiO₂) powder, and zirconium dioxide (ZrO₂) powder were weighed at a mass ratio of 94:5:0.8:0.2, added to aqueous solution, wetly ground for 24 h to 48 h and evenly mixed, then dried, and sifted through a sieve with a mesh of 5000 to 8000, to obtain mixed powder; and a polyvinyl alcohol (PVA) forming agent or a polyethylene glycol (PEG) forming agent was added to the mixed powder, wet grinding and mixing, drying, and sifting were performed, then mold pressing was performed under a pressure of 20 MPa to 40 MPa to form a designed shape, isostatic pressing was performed under a pressure of 100 MPa to 300 MPa to obtain a green body, and after the forming agent was removed, pressureless sintering was performed at 1100° C. to 1700° C. for 5 h to 12 h, to obtain conductive ceramic. Resistivity of the conductive ceramic was 2.436×10⁻³ Ω·cm, and porosity of the conductive ceramic was 5%. At the high temperature, Al³⁺, Ti⁴⁺, and Zr² obtained enough energy to enter a lattice of ZnO and replaced Zn²⁺, to provide an excess of free electrons, thereby playing the role of donor doping and improving conductivity of the ceramic, so that the ceramic can spontaneously generate heat.

In Embodiment 4, the conductive ceramic was approximately in a sheet shape, with a length of 19.5 mm, a width of 5 mm, and a thickness of 2.5 mm. Resistance of the conductive ceramic measured by using the LCR tester 40 was 38 mΩ.

Embodiment 5: Zinc oxide (ZnO) powder, aluminum oxide (Al₂O₃) powder, titanium dioxide (TiO₂) powder, and zirconium dioxide (ZrO₂) powder were weighed at a mass ratio of 94.4:5:0.4:0.2, added to aqueous solution, wetly ground for 24 h to 48 h and evenly mixed, then dried, and sifted through a sieve with a mesh of 5000 to 8000, to obtain mixed powder; and a polyvinyl alcohol (PVA) forming agent or a polyethylene glycol (PEG) forming agent was added to the mixed powder, wet grinding and mixing, drying, and sifting were performed, then mold pressing was performed under a pressure of 20 MPa to 40 MPa to form a designed shape, isostatic pressing was performed under a pressure of 100 MPa to 300 MPa to obtain a green body, and after the forming agent was removed, pressureless sintering was performed at 1100° C. to 1700° C. for 5 h to 12 h, to obtain conductive ceramic. Resistivity of the conductive ceramic was 2.06×10⁻² Ω·cm, and porosity of the conductive ceramic was 0.3%. At the high temperature, Al³⁺, Ti⁴⁺, and Zr² obtained enough energy to enter a lattice of ZnO and replaced Zn²⁺, to provide an excess of free electrons, thereby playing the role of donor doping and improving conductivity of the ceramic, so that the ceramic can spontaneously generate heat.

In Embodiment 5, the conductive ceramic was approximately in a needle shape, with a diameter of 2.5 mm and a length of 19 mm. Resistance of the conductive ceramic measured by using the LCR tester 40 was 0.8Ω.

Embodiment 6: Zinc oxide (ZnO) powder, aluminum oxide (Al₂O₃) powder, titanium dioxide (TiO₂) powder, and zirconium dioxide (ZrO₂) powder were weighed at a mass ratio of 96.2:3:0.6:0.2, added to aqueous solution, wetly ground for 24 h to 48 h and evenly mixed, then dried, and sifted through a sieve with a mesh of 5000 to 8000, to obtain mixed powder; and a polyvinyl alcohol (PVA) forming agent or a polyethylene glycol (PEG) forming agent was added to the mixed powder, wet grinding and mixing, drying, and sifting were performed, then mold pressing was performed under a pressure of 20 MPa to 40 MPa to form a designed shape, isostatic pressing was performed under a pressure of 100 MPa to 300 MPa to obtain a green body, and after the forming agent was removed, pressureless sintering was performed at 1100° C. to 1700° C. for 5 h to 12 h, to obtain conductive ceramic. Resistivity of the conductive ceramic was 7.3×10⁻³ Ω·cm, and porosity of the conductive ceramic was 1%. At the high temperature, Al³⁺, Ti⁴⁺, and Zr²⁺ obtained enough energy to enter a lattice of ZnO and replaced Zn²⁺, to provide an excess of free electrons, thereby playing the role of donor doping and improving conductivity of the ceramic, so that the ceramic can spontaneously generate heat.

In Embodiment 6, the conductive ceramic was approximately in a sheet shape, with a length of 19 mm, a width of 5 mm, and a thickness of 2 mm. Resistance of the conductive ceramic measured by using the LCR tester 40 was 0.14Ω.

Embodiment 7: Zinc oxide (ZnO) powder, aluminum oxide (Al₂O₃) powder, titanium dioxide (TiO₂) powder, and zirconium dioxide (ZrO₂) powder were weighed at a mass ratio of 96.7:3:0.2:0.1, added to aqueous solution, wetly ground for 24 h to 48 h and evenly mixed, then dried, and sifted through a sieve with a mesh of 5000 to 8000, to obtain mixed powder; and a polyvinyl alcohol (PVA) forming agent or a polyethylene glycol (PEG) forming agent was added to the mixed powder, wet grinding and mixing, drying, and sifting were performed, then mold pressing was performed under a pressure of 20 MPa to 40 MPa to form a designed shape, isostatic pressing was performed under a pressure of 100 MPa to 300 MPa to obtain a green body, and after the forming agent was removed, pressureless sintering was performed at 1100° C. to 1700° C. for 5 h to 12 h, to obtain conductive ceramic. Resistivity of the conductive ceramic was 6.3×10⁻³ Ω·cm, and porosity of the conductive ceramic was 1%. At the high temperature, Al³⁺, Ti⁴⁺ and Zr²⁺ obtained enough energy to enter a lattice of ZnO and replaced Zn²⁺, to provide an excess of free electrons, thereby playing the role of donor doping, and improving conductivity of the ceramic, so that the ceramic can spontaneously generate heat.

In Embodiment 7, the conductive ceramic was approximately in a sheet shape, with a length of 19 mm, a width of 4 mm, and a thickness of 2 mm. Resistance of the conductive ceramic measured by using the LCR tester 40 was 0.15Ω.

Optionally, the main component includes zinc oxide, and the doping component includes niobium pentoxide. A specific embodiment is as follows:

Embodiment 8: Zinc oxide (ZnO) powder, aluminum oxide (Al₂O₃) powder, zirconium dioxide (ZrO₂) powder, and niobium pentoxide (Nb₂O₅) powder were weighed at a mass ratio of (90 to 99.9):(0.5 to 10):(0 to 5):(0 to 5), added to aqueous solution, wetly ground for 24 h to 48 h and evenly mixed, then dried, and sifted through a sieve with a mesh of 5000 to 8000, to obtain mixed powder; and a polyvinyl alcohol (PVA) forming agent or a polyethylene glycol (PEG) forming agent was added to the mixed powder, wet grinding and mixing, drying, and sifting were performed, then mold pressing was performed under a pressure of 20 MPa to 40 MPa to form a designed shape, isostatic pressing was performed under a pressure of 100 MPa to 300 MPa to obtain a green body, and after the forming agent was removed, pressureless sintering was performed at 1100° C. to 1700° C. for 5 h to 12 h, to obtain conductive ceramic. Porosity of the conductive ceramic was less than 5%, and resistivity of the conductive ceramic was less than 5×10⁻² Ω·cm. At the high temperature, Al³⁺, Zr²⁺, and Nb⁵⁺ obtained enough energy to enter a lattice of ZnO and replaced Zn²⁺, to provide an excess of free electrons, thereby playing the role of donor doping and improving conductivity of the ceramic, so that the ceramic can spontaneously generate heat.

When the main component includes titanium dioxide, and the doping component includes at least niobium pentoxide, the resistivity of the conductive ceramic obtained based on the main component and the doping component is less than 8×10⁻² Ω·cm. A mass percentage of titanium dioxide in the conductive ceramic ranges from 85% to 95%; and a mass percentage of niobium pentoxide in the conductive ceramic ranges from 5% to 20%. A specific embodiment is as follows:

Embodiment 9: Titanium dioxide (TiO₂) powder and niobium pentoxide (Nb₂O₅) powder were weighed at a mass ratio of (85 to 95):(5 to 20), added to aqueous solution, wetly ground for 24 h to 48 h and evenly mixed, then dried, and sifted through a sieve with a mesh of 5000 to 8000, to obtain mixed powder; and a polyvinyl alcohol (PVA) forming agent or a polyethylene glycol (PEG) forming agent was added to the mixed powder, wet grinding and mixing, drying, and sifting were performed, then mold pressing are performed under a pressure of 20 MPa to 40 MPa to form a designed shape, isostatic pressing was performed under a pressure of 100 MPa to 300 MPa to obtain a green body, and after the forming agent was removed, pressureless sintering was performed at 1100° C. to 1600° C. for 5 h to 12 h, to obtain conductive ceramic. Porosity of the conductive ceramic was less than 3%, and resistivity of the conductive ceramic was less than 8×10⁻² Ω·cm. At the high temperature, Nb⁵⁺ obtained enough energy to enter a lattice of TiO₂ and replaced Ti⁴⁺, to provide an excess of free electrons, thereby playing the role of donor doping and improving conductivity of the ceramic; and at the high temperature, concentration of intrinsic defect oxygen vacancy of TiO₂ increased, to increase carrier concentration, thereby improving conductivity of the ceramic, so that the ceramic can spontaneously generate heat.

In another implementation, the valence of the metal in the first metal oxide is greater than the valence of the metal in the second metal oxide.

When the main component includes tantalum pentoxide, and the doping component includes at least one of titanium dioxide or zirconium dioxide, the resistivity of the conductive ceramic obtained based on the main component and the doping component ranges from 1×10⁻² Ω·cm to 6×10⁻² Ω·cm. A mass percentage of tantalum pentoxide in the conductive ceramic ranges from 80% to 98%. A specific embodiment is as follows:

Embodiment 10: Tantalum pentoxide (Ta₂O₅) powder and titanium dioxide (TiO₂) powder were weighed at a mass ratio of 92:8, added to aqueous solution, wetly ground for 24 h to 48 h and evenly mixed, then dried, and sifted through a sieve with a mesh of 5000 to 8000, to obtain mixed powder; and a polyvinyl alcohol (PVA) forming agent or a polyethylene glycol (PEG) forming agent was added to the mixed powder, wet grinding and mixing, drying, and sifting were performed, then mold pressing was performed under a pressure of 20 MPa to 40 MPa to form a designed shape, isostatic pressing was performed under a pressure of 100 MPa to 300 MPa to obtain a green body, and after the forming agent was removed, pressureless sintering was performed at 1100° C. to 1700° C. for 5 h to 12 h, to obtain conductive ceramic. Porosity of the conductive ceramic was 2%, and resistivity of the conductive ceramic was 3.28×10⁻² Ω·cm. At the high temperature, Ti⁴⁺ obtained enough energy to enter a lattice of Ta₂O₅ and replaced Ta⁵⁺, to provide an excess of free electrons, thereby playing the role of donor doping and improving conductivity of the ceramic, so that the ceramic can spontaneously generate heat.

Embodiment 11: Tantalum pentoxide (Ta₂O₅) powder and zirconium dioxide (ZrO₂) powder were weighed at a mass ratio of 82:18, added to aqueous solution, wetly ground for 24 h to 48 h and evenly mixed, then dried, and sifted through a sieve with a mesh of 5000 to 8000, to obtain mixed powder; and a polyvinyl alcohol (PVA) forming agent or a polyethylene glycol (PEG) forming agent was added to the mixed powder, wet grinding and mixing, drying, and sifting were performed, then mold pressing was performed under a pressure of 20 MPa to 40 MPa to form a designed shape, isostatic pressing was performed under a pressure of 100 MPa to 300 MPa to obtain a green body, and after the forming agent was removed, pressureless sintering was performed at 1100° C. to 1700° C. for 5 h to 12 h, to obtain conductive ceramic. Porosity of the conductive ceramic was 1%, and resistivity of the conductive ceramic was 4.1×10⁻² Ω·cm. At the high temperature, Zr⁴⁺ obtained enough energy to enter a lattice of Ta₂O₅ and replaced Ta⁵⁺, to provide an excess of free electrons, thereby playing the role of donor doping and improving conductivity of the ceramic, so that the ceramic can spontaneously generate heat.

Embodiment 12: Tantalum pentoxide ((Ta₂O₅) powder, titanium dioxide (TiO₂) powder, and zirconium dioxide (ZrO₂) powder were weighed at a mass ratio of 97:2:1, added to an aqueous solution, wetly ground for 24 h to 48 h and evenly mixed, then dried, and sifted through a sieve with a mesh of 5000 to 8000, to obtain mixed powder; and a polyvinyl alcohol (PVA) forming agent or a polyethylene glycol (PEG) forming agent was added to the mixed powder, wet grinding and mixing, drying, and sifting were performed, then mold pressing was performed under a pressure of 20 MPa to 40 MPa to form a designed shape, isostatic pressing was performed under a pressure of 100 MPa to 300 MPa to obtain a green body, and after the forming agent was removed, pressureless sintering was performed at 1100° C. to 1700° C. for 5 h to 12 h, to obtain conductive ceramic. Porosity of the conductive ceramic was 6%, and resistivity of the conductive ceramic was 3.1×10⁻² Ω·cm. At the high temperature, Ti⁴⁺ and Zr⁴⁺ obtained enough energy to enter a lattice of Ta₂O₅ and replaced Ta⁵⁺, to provide an excess of free electrons, thereby playing the role of donor doping and improving conductivity of the ceramic, so that the ceramic can spontaneously generate heat.

Further, the conductive ceramic further includes a conductive resistivity adjustment component, to control the resistivity of the conductive ceramic to be in a target range. In this embodiment, the resistivity of the conductive ceramic with the conductive resistivity adjustment component added ranges from 2×10⁻³ Ω·cm to 6×10⁻² Ω·cm. In other words, the resistivity adjustment component is added to control the resistivity of the conductive ceramic to range from 2×10⁻³ Ω·cm to 6×10⁻² Ω·cm, and resistivity in the target range may be designed as needed. A mass percentage of the conductive resistivity adjustment component in the conductive ceramic ranges from 1% to 19%.

The conductive resistivity adjustment component includes at least one of a conductive metal carbide, a conductive metal boride, conductive carbon powder, or conductive metal powder. Optionally, the metal carbide includes silicon carbide. Optionally, the metal boride includes titanium boride. Optionally, the conductive metal powder includes at least one of gold powder, silver powder, or copper powder. A specific embodiment is as follows:

Embodiment 13: Zinc oxide (ZnO) powder, titanium boride (TiB₂) powder, and aluminum oxide (Al₂O₃) powder were weighed at a mass ratio of (80 to 90):(4 to 10):(1 to 15), added to aqueous solution, wetly ground for 24 h to 48 h and evenly mixed, then dried, and sifted through a sieve with a mesh of 5000 to 8000, to obtain mixed powder; and a polyvinyl alcohol (PVA) forming agent or a polyethylene glycol (PEG) forming agent was added to the mixed powder, wet grinding and mixing, drying, and sifting were performed, then mold pressing was performed under a pressure of 20 MPa to 40 MPa to form a designed shape, isostatic pressing was performed under a pressure of 100 MPa to 300 MPa to obtain a green body, and after the forming agent was removed, pressureless sintering was performed at 1100° C. to 1600° C. for 5 h to 12 h, to obtain conductive ceramic. Porosity of the conductive ceramic was less than 8%, and resistivity of the conductive ceramic was less than 2×10⁻² Ω·cm. At the high temperature, Al³⁺ obtained enough energy to enter a lattice of ZnO and replaced Zn²⁺, to provide an excess of free electrons, thereby playing the role of donor doping, so that the ceramic can spontaneously generate heat; and TiB₂ had good conductivity, and at the high temperature, Ti⁴⁺ obtained enough energy to enter the lattice of ZnO, so that the role of donor doping can be played, that is, TiB₂ was used as the conductive resistivity adjustment component, to control the resistivity of the conductive ceramic to be less than 2×10⁻² Ω·cm.

This application further describes the material of the conductive ceramic in detail from another angle. The material of the conductive ceramic provided in this application includes a conductive component and a non-conductive component, where the conductive component includes at least one of a conductive metal boride, a conductive metal nitride, or a conductive metal carbide; and the non-conductive component includes at least one of a non-conductive metal oxide or a non-conductive metal nitride. In this implementation, the conductive component has conductivity, which makes the conductive component have a self-heating function, so that a circuit is prevented from being printed on a surface of the ceramic, and a problem of circuit falling caused by friction due to frequent use is also avoid, which is beneficial to improving use experience of a user and prolonging service life of an aerosol generation apparatus.

In an implementation, the conductive component includes at least one of titanium boride, titanium nitride, titanium carbide, or silicon carbide. In an implementation, the non-conductive component includes at least one of silicon dioxide or zirconium dioxide. A mass percentage of the conductive component in the conductive ceramic ranges from 20% to 80%; and further, a mass percentage of the non-conductive component in the conductive ceramic ranges from 20% to 80%. A specific embodiment is as follows:

Embodiment 14: Zirconium dioxide (ZrO₂), titanium boride (TiB₂), and glass powder were weighed at a mass ratio of (30 to 60):(40 to 70):(0 to 5), added to aqueous solution, wetly ground for 24 h to 48 h and evenly mixed, then dried, and sifted through a sieve with a mesh of 5000 to 8000, to obtain mixed powder; and a polyvinyl alcohol (PVA) forming agent or a polyethylene glycol (PEG) forming agent was added to the mixed powder, wet grinding and mixing, drying, and sifting were performed, then mold pressing was performed under a pressure of 20 MPa to 40 MPa to form a designed shape, isostatic pressing was performed under a pressure of 100 MPa to 300 MPa to obtain a green body, and after the forming agent was removed, sintering was performed at 1500° C. to 2200° C. under protective gas (such as argon or nitrogen) for 5 h to 12 h, to obtain conductive ceramic. Porosity of the conductive ceramic was less than 5%, and resistivity of the conductive ceramic was less than 6×10⁻³ Ω·cm. TiB₂ had good conductivity, and after TiB₂ was mixed with zirconium dioxide, TiB₂ acted as a conductive network, thereby improving conductivity of the ceramic, so that the ceramic can spontaneously generate heat.

In Embodiment 14, the material of the conductive ceramic further included an additive, where the additive included at least glass powder. It may be understood that, the additive is an optional material, to facilitate forming of the conductive ceramic.

Embodiment 15: Zirconium dioxide (ZrO₂), titanium boride (TiB₂), and silicon dioxide (SiO₂) were weighed at a mass ratio of (30 to 60):(40 to 70):(0.1 to 5), added to aqueous solution, wetly ground for 24 h to 48 h and evenly mixed, then dried, and sifted through a sieve with a mesh of 5000 to 8000, to obtain mixed powder; and a polyvinyl alcohol (PVA) forming agent or a polyethylene glycol (PEG) forming agent was added to the mixed powder, wet grinding and mixing, drying, and sifting were performed, then mold pressing was performed under a pressure of 20 MPa to 40 MPa to form a designed shape, isostatic pressing was performed under a pressure of 100 MPa to 300 MPa to obtain a green body, and after the forming agent was removed, sintering was performed at 1500° C. to 2200° C. under protective gas (such as argon or nitrogen) for 5 h to 12 h, to obtain conductive ceramic. Porosity of the conductive ceramic was less than 2%, and resistivity of the conductive ceramic was less than 2.9×10⁻³ Ω·cm. TiB₂ had good conductivity, and acted as a conductive network, thereby improving conductivity of the ceramic, so that the ceramic can spontaneously generate heat.

Further, the conductive ceramic further includes a conductive resistivity adjustment component, and a mass percentage of the conductive resistivity adjustment component in the conductive ceramic ranges from 0% to 50%. In this embodiment, the resistivity of the conductive ceramic with the conductive resistivity adjustment component added ranges from 1×10⁻⁴ Ω·cm to 1.3×10⁻¹ Ω·cm. In other words, the resistivity adjustment component is added to control the resistivity of the conductive ceramic to range from 1×10⁻⁴ Ω·cm to 1.3×10⁻¹ Ω·cm, and a control range of the resistivity may be designed as needed.

The conductive resistivity adjustment component includes at least one of a conductive metal carbide, a conductive metal boride, conductive carbon powder, or conductive metal powder. Optionally, the metal carbide includes silicon carbide. Optionally, the metal boride includes titanium boride. Optionally, the conductive metal powder includes at least one of gold powder, silver powder, or copper powder. A specific embodiment is as follows:

Embodiment 16: Silicon carbide (SiC), titanium boride (TiB₂), and glass powder were weighed at a mass ratio of (20 to 50):(50 to 80):(0 to 2), added to aqueous solution, wetly ground for 24 h to 48 h and evenly mixed, then dried, and sifted through a sieve with a mesh of 5000 to 8000, to obtain mixed powder; and a polyvinyl alcohol (PVA) forming agent or a polyethylene glycol (PEG) forming agent was added to the mixed powder, wet grinding and mixing, drying, and sifting were performed, then mold pressing was performed under a pressure of 20 MPa to 40 MPa to form a designed shape, isostatic pressing was performed under a pressure of 100 MPa to 300 MPa to obtain a green body, and after the forming agent was removed, sintering was performed at 1500° C. to 2200° C. under protective gas (such as hydrogen, argon, or nitrogen) for 5 h to 12 h, to obtain conductive ceramic. Porosity of the conductive ceramic was less than 10%, resistivity of the conductive ceramic was less than 1×10⁻³ Ω·cm. TiB₂ had good conductivity, so that the ceramic can spontaneously generate heat; and SiC was used as the conductive resistivity adjustment component, to control the resistivity of the conductive ceramic to be less than 1×10⁻³ Ω·cm.

In Embodiment 16, the material of the conductive ceramic further included an additive, where the additive included at least glass powder. It may be understood that, the additive is an optional material, to facilitate forming of the conductive ceramic.

Embodiment 17: Silicon carbide (SiC), titanium boride (TiB₂), and silicon dioxide (SiO₂) were weighed at a mass ratio of (20 to 50):(50 to 80):(0.1 to 2), added to aqueous solution, wetly ground for 24 h to 48 h and evenly mixed, then dried, and sifted through a sieve with a mesh of 5000 to 8000, to obtain mixed powder; and a polyvinyl alcohol (PVA) forming agent or a polyethylene glycol (PEG) forming agent was added to the mixed powder, wet grinding and mixing, drying, and sifting were performed, then mold pressing was performed under a pressure of 20 MPa to 40 MPa to form a designed shape, isostatic pressing was performed under a pressure of 100 MPa to 300 MPa to obtain a green body, and after the forming agent was removed, sintering was performed at 1500° C. to 2200° C. under protective gas (such as argon or nitrogen) for 5 h to 12 h, to obtain conductive ceramic. Porosity of the conductive ceramic was less than 1%, and resistivity of the conductive ceramic was less than 2.98×10⁻³ Ω·cm. TiB₂ had good conductivity, so that the ceramic can spontaneously generate heat; and SiC was used as the conductive resistivity adjustment component, to control the resistivity of the conductive ceramic to be less than 2.98×10⁻³ Ω·cm.

Embodiment 18: Zirconium dioxide (ZrO₂), titanium boride (TiB₂), and copper powder (or silver powder or gold powder) were weighed at a mass ratio of (30 to 50):(20 to 50):(10 to 30), added to aqueous solution, wetly ground for 24 h to 48 h and evenly mixed, then dried, and sifted through a sieve with a mesh of 5000 to 8000, to obtain mixed powder; and a polyvinyl alcohol (PVA) forming agent or a polyethylene glycol (PEG) forming agent was added to the mixed powder, wet grinding and mixing, drying, and sifting were performed, then mold pressing was performed under a pressure of 20 MPa to 40 MPa to form a designed shape, isostatic pressing was performed under a pressure of 100 MPa to 300 MPa to obtain a green body, and after the forming agent was removed, sintering was performed at 1100° C. to 2200° C. under protective gas (such as argon or nitrogen) for 5 h to 12 h, to obtain conductive ceramic. Porosity of the conductive ceramic was less than 3%, and resistivity of the conductive ceramic was less than 5×10⁻³ Ω·cm. TiB₂ and copper powder (or silver powder or gold powder) had good conductivity, and TiB₂ and copper powder (or silver powder or gold powder), when mixed with the ceramic, acted as a conductive network, thereby improving conductivity of the ceramic, so that the ceramic can spontaneously generate heat. Cu powder (or silver powder or gold powder) was used as the conductive resistivity adjustment component, to control the resistivity of the conductive ceramic to be less than 5×10⁻³ Ω·cm.

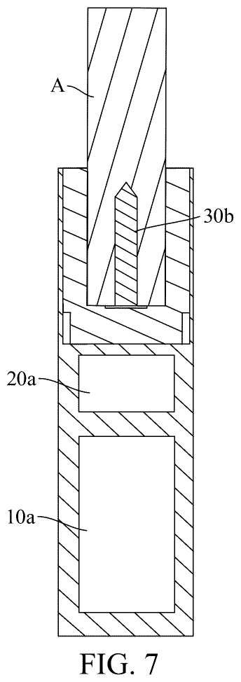

Refer to FIG. 7. FIG. 7 is a schematic structural diagram of an aerosol generation apparatus according to another embodiment of this application.

Another embodiment of this application further provides an aerosol generation apparatus, and a structure thereof is shown in FIG. 7, including:
a chamber, for receiving a solid aerosol generation product A;
a resistive heater 30b, where at least a part of the resistive heater 30b extends in the chamber to heat the aerosol generation product A to generate an aerosol for inhalation;
a battery cell 10a, configured to supply power; and
a controller 20a, configured to guide a current between the battery cell 10a and the resistive heater 30b.

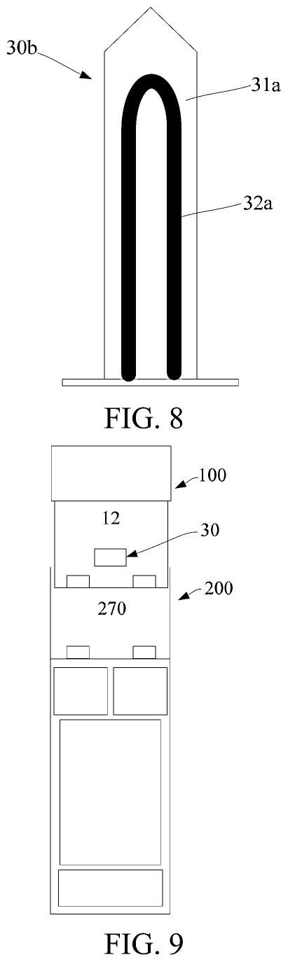

Refer to FIG. 8. FIG. 8 is a schematic structural diagram of an embodiment of a resistive heater for use in the aerosol generation apparatus provided in FIG. 7.

For a structure of an embodiment of the resistive heater 30b, refer to FIG. 8. The resistive heater 30b includes:
an electrically insulating substrate 31a, where a material of the electrically insulating substrate 31a may be, for example, ceramic, rigid plastic, surface insulating metal, or polyimide, where preferably, the electrically insulating substrate 31a is in a rigid pin shape or a thin blade shape, which can be inserted into the aerosol generation product A during use to heat the aerosol generation product A; or in other varying implementations, the electrically insulating substrate 31a may also be in a tube shape surrounding the chamber/aerosol generation product A; and
a resistive heating trace 32a combined on the electrically insulating substrate 31a by printing, depositing, or the like. The resistive heating trace 32a may be formed by using the foregoing material of the conductive ceramic introduced above. This is not described again.

Refer to FIG. 9. FIG. 9 is a schematic structural diagram of an aerosol generation apparatus according to still another embodiment of this application.

A still another embodiment of this application further provides an aerosol generation apparatus. For a structure of the aerosol generation apparatus is shown in FIG. 9. The aerosol generation apparatus includes: an atomizer 100 storing a liquid substrate and atomizing the liquid substrate to generate an aerosol, and a power supply assembly 200 supplying power to the atomizer 100.

In an optional implementation, as shown in FIG. 9, the power supply assembly 200 includes a receiving cavity 270 arranged at an end in a length direction and for receiving and accommodating at least a part of the atomizer 100. When at least a part of the atomizer 100 is received and accommodated in the power supply assembly 200, an electrical connection is formed between the power supply assembly 200 and the atomizer 100 to supply power to the atomizer 100. In addition, the atomizer 100 may be removed from the receiving cavity 270, to facilitate replacement and independent storage.

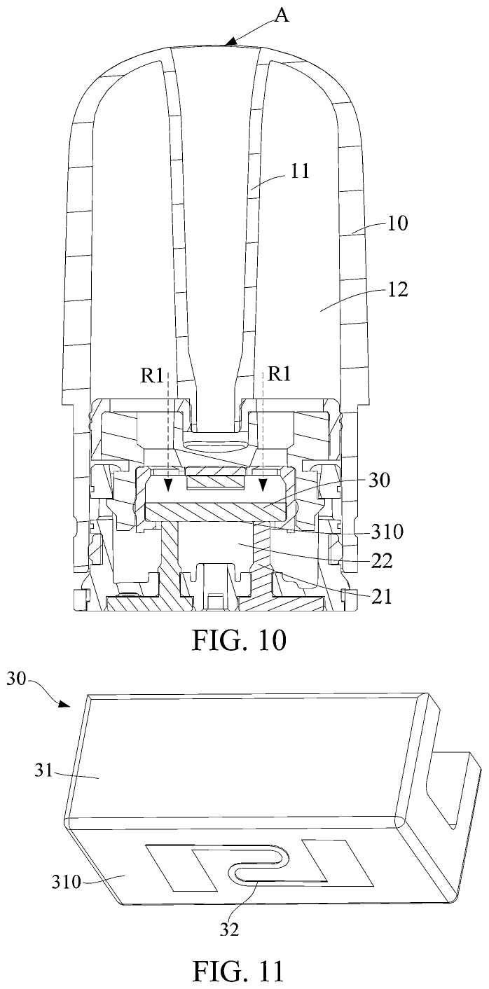

Refer to FIG. 10. FIG. 10 is a schematic structural diagram of the atomizer of the aerosol generation apparatus provided in FIG. 9.

The atomizer 100 includes:
a liquid storage cavity 12 for storing a liquid substrate and a heating assembly 30 for absorbing the liquid substrate and heating and atomizing the liquid substrate to generate the aerosol.

Further, FIG. 10 shows a schematic structural diagram of an embodiment of the atomizer 100 in FIG. 9. The atomizer 100 includes:
a main housing 10;
a suction nozzle A, formed at an upper end of the main housing 10, and configured for a user to inhale the aerosol;
a flue gas output pipe 11, extending in a longitudinal direction of the main housing 10, and configured to output the aerosol to the suction nozzle A;
the liquid storage cavity 12, defined by the flue gas output pipe 11 and an inner wall of the main housing 10, and for storing the liquid substrate;
a heating assembly 30, coming into fluid communication with the liquid storage cavity 12 at an upper side in a longitudinal direction of the atomizer 100, as shown by an arrow R1 in FIG. 10, where the liquid substrate of the liquid storage cavity 12 flows to the heating assembly 30 to be absorbed; and the heating assembly 30 has an atomization surface 310 away from the liquid storage cavity 12, and the atomization surface 310 is for heating the liquid substrate and releasing the generated aerosol;
an atomization chamber 22, defined by the atomization surface 310, and for accommodating the released aerosol, where the atomization chamber 22 is in airflow communication with the flue gas output pipe 11, to output the aerosol to the flue gas output pipe 11; and an electrical contact 21, configured to supply power to the heating assembly 30.

Refer to FIG. 11. FIG. 11 is a schematic structural diagram of the heating assembly of the atomizer provided in FIG. 10.

A specific construction of the heating assembly 30 includes:
a porous body 31, where in some implementations, the porous body 31 may be made of a rigid capillary structure such as porous ceramic, porous glass ceramic, or porous glass; and in an implementation, a flat surface of the porous body 31 away from the liquid storage cavity 12 is configured as the atomization surface 310; and
a resistive heating trace 32, where in some implementations, the resistive heating trace 32 is formed on the atomization surface 310 by sintering after conductive raw material powder and a printing aid are mixed into resistive paste and the paste is printed, so that all or most of a surface of the resistive heating trace 32 is tightly bonded to the atomization surface 320.

In other varying implementations, the porous body 31 may also be in a flat plate shape, a concave shape with a concave cavity toward an upper surface of the liquid storage cavity 12, an arch shape with an arch structure on one side of the liquid storage cavity 12, or the like.

In other preferred implementations, the resistive heating trace 32 is a patterned trace.

In other preferred implementations, the resistive heating trace 32 is formed by stamping or printing.

In other preferred implementations, the resistive heating trace 32 is in a plane shape.

In other preferred implementations, the resistive heating trace 32 is a trace extending meanderingly, circuitously, or the like.

In other preferred implementations, the resistive heating trace 32 has a thickness of about 60 m to 100 m.

After assembly, the electrical contact 21 abuts against two ends of the resistive heating trace 32 to form a conductive connection, to supply power to the resistive heating trace 32. The resistive heating trace 32 may be formed by using the foregoing material of the conductive ceramic introduced above. This is not described again.

The foregoing are only implementations of this application, and do not limit the patent scope of this application. Equivalent structures or equivalent process transformation made using the specification and the accompanying drawings of this application, or directly or indirectly applied in other related technical fields, are also included in the patent protection scope of this application.

1. A resistive heater for use in an aerosol generation apparatus, comprising conductive ceramic, wherein resistivity of the conductive ceramic ranges from 1×10⁻⁴ Ω·cm to 1.3×10⁻¹ Ω·cm.

2. The resistive heater for use in an aerosol generation apparatus according to claim 1, wherein a material of the conductive ceramic comprises a main component and a doping component.

3. The resistive heater for use in an aerosol generation apparatus according to claim 2, wherein a mass percentage of the main component in the conductive ceramic is greater than 80% and less than or equal to 98%.

4. The resistive heater for use in an aerosol generation apparatus according to claim 3, wherein a mass percentage of the doping component in the conductive ceramic is greater than 0.5% and less than or equal to 19%.

5. The resistive heater for use in an aerosol generation apparatus according to claim 2, wherein the main component comprises a first metal oxide, and the doping component comprises a second metal oxide; and
a valence of metal in the first metal oxide is different from a valence of metal in the second metal oxide.

6. The resistive heater for use in an aerosol generation apparatus according to claim 5, wherein the valence of the metal in the first metal oxide is less than the valence of the metal in the second metal oxide.

7. The resistive heater for use in an aerosol generation apparatus according to claim 6, wherein the main component comprises zinc oxide; and the doping component comprises at least one of aluminum oxide, zirconium dioxide, titanium dioxide, or niobium pentoxide.

8. The resistive heater for use in an aerosol generation apparatus according to claim 7, wherein a mass percentage of the zinc oxide in the conductive ceramic ranges from 94% to 98%; and the doping component comprises aluminum oxide, and a mass percentage of the aluminum oxide in the conductive ceramic ranges from 0.5% to 5%.

9. (canceled)

10. The resistive heater for use in an aerosol generation apparatus according to claim 6, wherein the main component comprises titanium dioxide; and the doping component comprises at least niobium pentoxide.

11. The resistive heater for use in an aerosol generation apparatus according to claim 10, wherein a mass percentage of the titanium dioxide in the conductive ceramic ranges from 85% to 95%; and a mass percentage of the niobium pentoxide in the conductive ceramic ranges from 5% to 20%.

12. (canceled)

13. The resistive heater for use in an aerosol generation apparatus according to claim 5, wherein the valence of the metal in the first metal oxide is greater than the valence of the metal in the second metal oxide.

14. The resistive heater for use in an aerosol generation apparatus according to claim 13, wherein the main component comprises tantalum pentoxide; and the doping component comprises at least one of titanium dioxide or zirconium dioxide.

15. The resistive heater for use in an aerosol generation apparatus according to claim 1, wherein the conductive ceramic further comprises a conductive resistivity adjustment component, to control the resistivity of the conductive ceramic to be in a target range.

16. The resistive heater for use in an aerosol generation apparatus according to claim 15, wherein the conductive resistivity adjustment component comprises at least one of a conductive metal carbide, a conductive metal boride, conductive carbon powder, or conductive metal powder.

17. The resistive heater for use in an aerosol generation apparatus according to claim 15, wherein a mass percentage of the conductive resistivity adjustment component in the conductive ceramic ranges from 1% to 19%.

18. (canceled)

19. The resistive heater for use in an aerosol generation apparatus according to claim 1, wherein porosity of the conductive ceramic ranges from 0.01% to 10%.

20. (canceled)

21. (canceled)

22. The resistive heater for use in an aerosol generation apparatus according to claim 1, wherein the conductive ceramic comprises a conductive component and a non-conductive component, wherein the conductive component comprises at least one of a conductive metal boride, a conductive metal nitride, or a conductive metal carbide; and the non-conductive component comprises at least one of a non-conductive metal oxide or a non-conductive metal nitride.

23. The resistive heater for use in an aerosol generation apparatus according to claim 22, wherein the conductive component comprises at least one of titanium boride, titanium nitride, or titanium carbide.

24. (canceled)

25. A resistive heater for use in an aerosol generation apparatus, comprising conductive ceramic, wherein a material of the conductive ceramic comprises a main component and a doping component; a mass percentage of the main component in the conductive ceramic is greater than 80% and less than or equal to 98%;
the main component comprises a first metal oxide, and the doping component comprises a second metal oxide; and a valence of metal in the first metal oxide is different from a valence of metal in the second metal oxide.

26. An aerosol generation apparatus, configured to heat an aerosol generation product to generate an aerosol for inhalation, and comprising:
a chamber, for receiving the aerosol generation product; and
a resistive heater, configured to heat the aerosol generation product received in the chamber, wherein the resistive heater is the resistive heater for use in an aerosol generation apparatus according to claim 1.
